(19) United States
(12) Patent Application Publication
(10) Pub. No.: US 2014/0084787 A1
(43) Pub. Date: Mar. 27, 2014

(54) POWER CONVERTER CONTAINED BASE, LAMP WITH POWER CONVERTER CONTAINED BASE AND LAMP WITH SEPARABLE POWER CONVERTER CONTAINED BASE

(71) Applicant: Chang Wah Electromaterials Inc., Kaohsiung (TW)

(72) Inventor: WEN-KUEI TSAI, Taipei City (TW)

(73) Assignee: Chang Wah Electromaterials Inc., Kaohsiung (TW)

(21) Appl. No.: 14/037,816

(22) Filed: Sep. 26, 2013

(30) Foreign Application Priority Data
Sep. 27, 2012 (TW) 101135470

(51) Int. Cl. F21V 29/00

(52) U.S. Cl. CPC F21V 29/004
USPC 315/50; 315/32

(57) ABSTRACT

The present invention discloses a power converter contained base, lamp with power converter contained base and lamp with separable power converter contained base. The power converter contained base comprises a first commercial standard base, fundament, cover, power converter and a first connector. The fundament comprises a first opening connected to the commercial standard base and a second opening where the cover disposed. A containing space may be defined by the cover, base and the first commercial standard base. The power converter may be disposed inside the containing space. The first connector may be disposed on the cover or the fundament to be connected with a second connector of a light-emitting member to make the four elements, the first commercial standard base, the power converter, the one of or the combination of two or three of, the fundament, the cover and the connector, and the light-emitting member become electrically connected.

### CROSS-REFERENCE TO RELATED APPLICATION

This application claims the benefit of Taiwan Patent Application No. 101135470, filed on Sep. 27, 2012, in the Taiwan Intellectual Property Office, the disclosure of which is incorporated herein in its entirety by reference.

### BACKGROUND OF THE INVENTION

1. Field of the Invention

The present invention generally relates to a power converter contained base, in particular to a power converter contained base capable of being connected to a light-emitting member or a thermal dissipator through a connector, a lamp with power converter contained base and a lamp with separable power converter contained base.

2. Description of the Related Art

In the present day, light-emitting diodes (LEDs) remain common and widely-used electronic components. With merits such as small size, quick response, long service life, low power consumption and low thermal generation, they hold recognition as one of the most popular components used in electronic products. Accordingly, in recent years, as LED lamps become excellent substitutes for conventional incandescent lamps or fluorescent lamps, various LED lamps continue to be developed.

Currently available LED lamp bodies usually simultaneously function as a thermal dissipator and a chamber for accommodating a power converter. Thermal energy generated by the LED and the power converter can be conducted to the outside of the LED lamp's body by way of the thermal dissipator. Although the aforementioned structure is helpful for thermal dissipation and insulation, the thermal dissipation ability of the thermal dissipator is severely limited due to its insufficient surface area. Accordingly, the structure is not applicable to a LED lamp with higher power. Besides, the structure needs a lot of space to accommodate the thermal dissipator and the power converter, which leads to the relatively large size of the LED lamp. Furthermore, as a large amount of thermal heat is generated when the LED is working and the power converter is disposed in the accommodating space for dissipating the thermal energy generated by the LED, electronic components installed at the power converter are apt to be damaged due to overheating, which can reduce the LED lamp's service life. Thus, it has become an urgent issue to develop a LED lamp which has small size, great thermal dissipation ability, modularized components and is applicable to LED lamps with high power.

### SUMMARY OF THE INVENTION

Therefore, it is one of the primary objectives of the present invention to provide a power converter contained base, a lamp with a power converter contained base and a lamp with a separable power converter contained base to resolve the problems in conventional lamps or bases, such as large size and poor thermal dissipation. The objective includes making it possible for the components of the base or lamp to be respectively modularized so as to be individually manufactured, and further for the base to be applicable to a LED lamp with higher power.

To achieve the foregoing objective, the present invention provides a power converter contained base. The base may comprise a first commercial standard base, a fundament, a cover, a power converter and a first connector. Two ends of the fundament may respectively comprise a first opening and a second opening, and the first opening may be connected to the first commercial standard base. The cover may be disposed at the second opening of the fundament, wherein an accommodating space may be defined by the cover, the fundament and the first commercial standard base. The power converter may be disposed in the accommodating space. The first connector may be disposed at the cover or the fundament, wherein the first connector may be used to connect the power converter contained base with a second connector of a lighting-emitting member to make the first commercial standard base, the power converter, the one of or the combination of two or three of, the fundament, the cover and the first connector, and the light-emitting member become electrically connected.

To achieve the foregoing objective, the present invention further provides a lamp with separable power converter contained base. The lamp may comprise a power converter contained base and a light-emitting member. The power converter contained base may comprise a first commercial standard base, a fundament, a cover, a power converter and a first connector. Two ends of the fundament may respectively comprise a first opening and a second opening, wherein the first opening may be connected to the first commercial standard base. The cover may be disposed at the second opening of the fundament, wherein an accommodating space is defined by the cover, the fundament and the first commercial standard base. The power converter may be disposed in the accommodating space. The light-emitting member may comprise a second connector. The first connector may be disposed at the cover or the fundament, and the first connector may be used to connect the power converter contained base with and fix the power converter contained base to the second connector of the light-emitting member in order to make the first commercial standard base, the power converter, the one of or the combination of two or three of, the fundament, the cover and the first connector, and the light-emitting member become electrically connected.

To achieve the foregoing objective, the present invention still further provides a lamp with power converter contained base. The lamp may comprise a power converter contained base and a light-emitting member. The power converter contained base may comprise a first commercial standard base, a fundament, a power converter and a first connector. Two ends of the fundament may respectively comprise a first opening and a second opening, wherein the first opening may be connected to the first commercial standard base. An accommodating space is defined by the fundament and the first commercial standard base. The power converter may be disposed in the accommodating space. T light-emitting member may comprise a thermal dissipater, a light-emitting module and a second connector disposed at the thermal dissipater. The first connector may be disposed at the fundament, and the first connector is used to connect the power converter contained base with and fix the power converter contained base to the second connector of the thermal dissipater in order to make the thermal dissipater cover the second opening of the fundament and make the first commercial standard base, the power converter and the light module electrically connected to each other.

The power converter contained base according to the present invention is applicable to the power conversion of a bump or a lamp. The power converter contained base, the lamp with power converter contained base and the lamp with separable power converter contained base have the following advantages:

(1) Compared with the prior art, the power converter is completely disposed inside the base. Accordingly, the thermal generated by the power converter may be conducted to the outside of the base through the base's metal housing and its conductive wires, which may significantly extend the power converter's service life.

(2) Each of the components of the lamp according to the present invention may be separately modularized to be respectively sold or manufactured. Accordingly, consumers can replace the light-emitting member or other components at will. Besides, as LED lamp's service life is a multiple of the conventional incandescent lamp's and its luminous efficiency is keeping improving, consumers may take the improvement in luminous efficiency between old products and new products into consideration to determine whether or not to replace old products with new products for more energy saving or higher luminous efficiency. Moreover, the base is further disposed with a power adjustment component for adjusting the power converter's power to match the light-emitting member's, which is more convenient for users.

(3) Accordingly to the present invention, a space may be left between the cover and the light-emitting member and the space is advantageous to thermal dissipation and insulation. Accordingly, the performance of the LED lamp can be improved.

(4) The present invention may further comprise a third connector disposed at the fundament, the cover or the light-emitting member for a decorative component to be installed on, which can change the present invention's appearance and make it more beautiful.

(5) The power converter of the present invention is disposed in the accommodating space inside the base. Accordingly, electromagnetic radiation generated by the power converter can be effectively blocked by the metal housing of the base.

(6) Each of the components of the lamp according to the present invention may be separately modularized to be manufactured or sold respectively, which makes it more flexible for consumers to use or replace the components. Additionally, the manufacturing cost of the product can be further reduced; therefore, consumers can purchase the LED lamp or its components at more competitive price. Thus, the present invention is of high commercial value.

### BRIEF DESCRIPTION OF THE DRAWINGS

The detailed structure, operating principle and effects of the present invention will now be described in more details hereinafter with reference to the accompanying drawings that show various embodiments of the invention as follows.

FIG. 1 is a schematic view of a power converter contained base of one preferred embodiment in accordance with the present invention.

FIG. 2A is a first schematic view of a lamp with power converter contained base of one preferred embodiment in accordance with the present invention.

FIG. 2B is a second schematic view of a lamp with power converter contained base of one preferred embodiment in accordance with the present invention.

FIG. 3 is a schematic view of a lamp with separable power converter contained base of one preferred embodiment in accordance with the present invention.

FIG. 4 is a schematic view of a lamp with power converter contained base and thermal dissipation paths of one preferred embodiment in accordance with the present invention.

FIG. 5 is a schematic view of a lamp with separable power converter contained base of another preferred embodiment in accordance with the present invention.

FIG. 6 is a schematic view of a lamp with separable power converter contained base of still another preferred embodiment in accordance with the present invention.

FIG. 7 is a schematic view of a lamp with power converter contained base of another preferred embodiment in accordance with the present invention.

### DETAILED DESCRIPTION OF THE PREFERRED EMBODIMENTS

The detailed description of the present invention will be discussed in the following embodiments, which are not intended to limit the scope of the present invention, but can be adapted for other applications. While drawings are illustrated in details, it is appreciated that the quantity of the disclosed components may be greater or less than that disclosed, except expressly restricting the amount of the components. Although specific embodiments have been illustrated and described, it will be appreciated by those skilled in the art that various modifications may be made without departing from the scope of the present invention, which is intended to be limited solely by the appended claims.

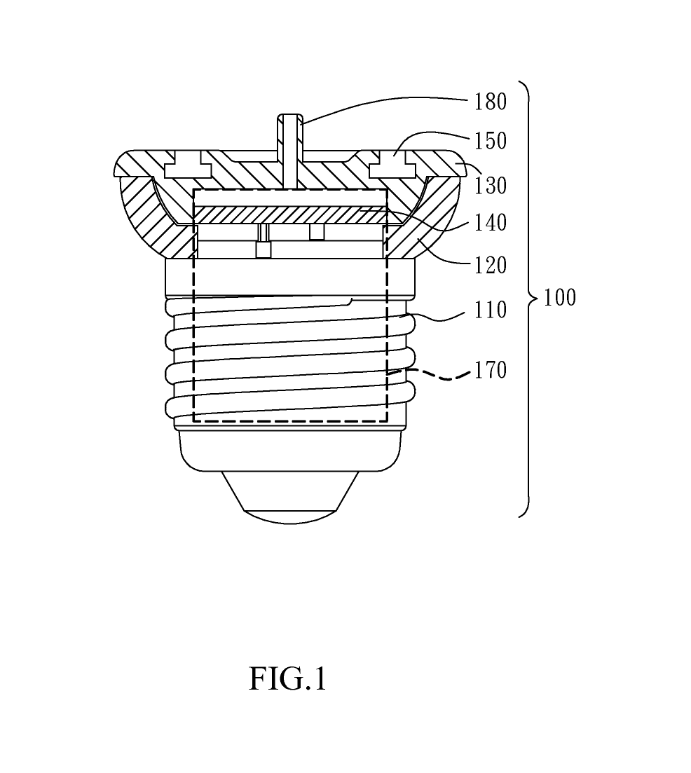

Referring more particularly to the drawings, FIG. 1 is a schematic view of a power converter contained base of one preferred embodiment in accordance with the present invention. The power converter contained base 100 may comprise a first commercial standard base 110, a fundament 120, a cover 130, a power converter 140 and a first connector 150. As shown in FIG. 1, the cover 130 may be disposed above the fundament 120 and the first commercial standard base 110 may be disposed below the fundament 120. An accommodating space 170 (shown with broken lines) may be defined by the first commercial standard base 110, the fundament 120 and the cover 130 to accommodate the power converter 140.

The first commercial standard base 110 described in the application may be E26, E27 or other commercial standard base and thereby the power converter contained base may be fixed to and electrically connected to the commercial standard socket in order to be powered by external AC or DC power source.

The fundament 120 of the present invention functions as a connector for connecting the light-emitting member with the thermal dissipater, and the cover 130 is combined with the fundament 120 and the first commercial standard base 110 to define an accommodating space 170 to achieve thermal insulation and dustproof. Apparently, the fundament 120 and the cover 130 may be further minified or integrally formed, such that the accommodating space 170 may be the internal space inside the first commercial standard base 110.

As shown in FIG. 1, the first connector 150 is disposed at the cover 130 to be connected to the second connector of an external light-emitting member (not shown). Those skilled in the art would easily understand that the first connector 150 may also be disposed at the fundament 120 as long as the first connector 150 can be connected to an external light-emitting member.

The power converter according to the present invention is used to convert the external AC or DC power source into the power source that the light-emitting member needs. Accordingly, the components inside the power converter contained base should be able to achieve electrical connection. For example, electrical connection may be achieved through the first commercial standard base 110, the power converter 140, the cover 130 and the first connector 150. Those skilled in the art would easily understand that the first commercial standard base 110 and the power converter 140 may be selectively electrically connected to one, two or three of the fundament 120, the cover 130 and the first connector 150 to achieve electrical connection.

In some preferred embodiments, the accommodating space may further comprise thermal conducting material. Accordingly, thermal generated by the power converter 140 may be conducted to the first commercial standard base 110 by the thermal conducting material to enhance the thermal dissipation and then render the power converter 140 more stable.

The first connector 150 is mainly used in connection. For example, the first connector 150 may be a hook, a notch, male thread or female thread to be engaged with or fastened to the connector of the light-emitting member. In some preferred embodiments, the first connector 150 may also be used to electrically connect the power converter 140 with the light-emitting member. The first connector 150 may comprise a conductive metal bar, a metal shrapnel or the like, or a commercial standard connector for electrical connection. For example, the first connector 150 may be a GU type base or socket, which may comprise but not be limited to GU5.3, GU10, GU24 and B22D type base or socket to be connected to a matched socket or base so as to achieve fixation and electrical connection. However, the commercial standard connector may tend to be accidentally connected to the different product with the same base and socket by a user. Accordingly, the power converter contained base 100 may further comprise various types of fool-proof apparatuses (such a protrusion) to prevent the damage resulting from user's misuse.

It is worthy to point out that the power converter of the power converter contained base according to the present invention is disposed in the space defined by the cover, the fundament and the first commercial standard base. Accordingly, when the power converter is working, the electromagnetic radiation generated by the power converter can be blocked by the base's metal housing, which can effectively reduce the electromagnetic radiation generated by the power converter. In addition, thermal generated by the power converter can be conducted to the outside of the base via the thermal conducting material, the base, the socket to which the base is connected and corresponding conducting wires. Moreover, the components of the base and the socket may be further made of metal, ceramics, thermally conductive plastics and the like to effectively improve the thermal dissipation of the power converter and thereby render the power converter more stable.

In some preferred embodiments, the surface of the power converter contained base, such as the surface of the cover 120 or the base 130, may comprise a power adjustment component. The component may be a cross knob, a pointer type knob or a protruded knob for a user to adjust the output of the power converter by a screwdriver or his own hand. The component may just be a hole on the cover 120 or the base 130 for a screwdriver and the like to be put into to adjust the output of the power converter.

Installed on the power converter contained base according to the present invention may be a LED light source, an OLED light source or any light source needing to be powered by the power converter which performs power transformation on an external AC or DC power source.

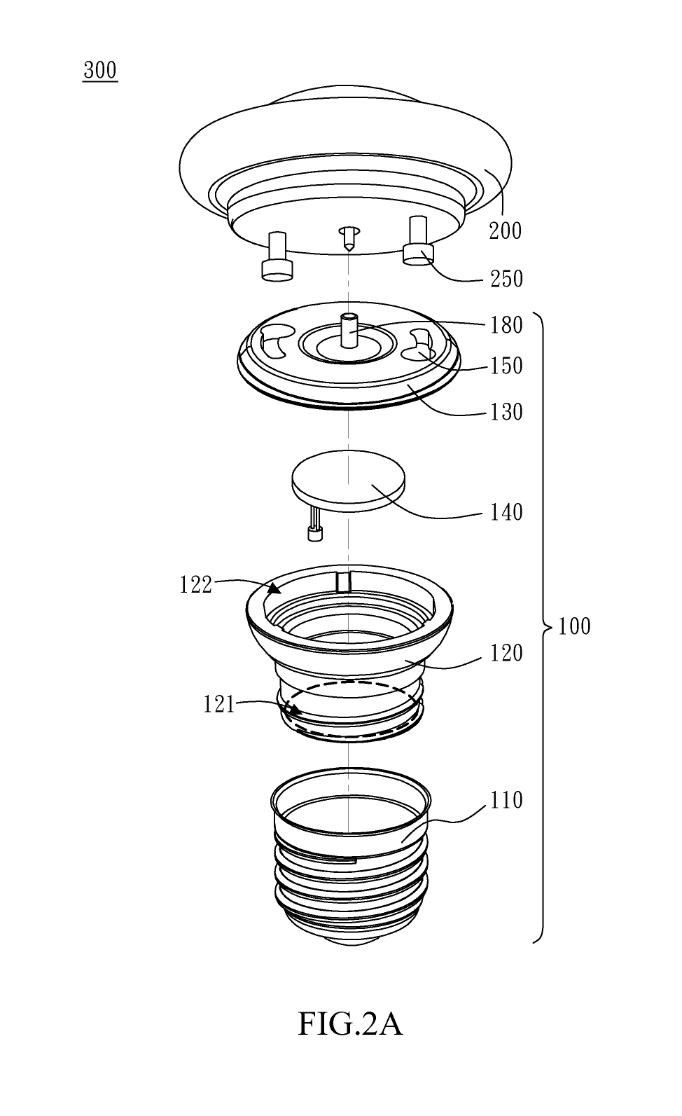

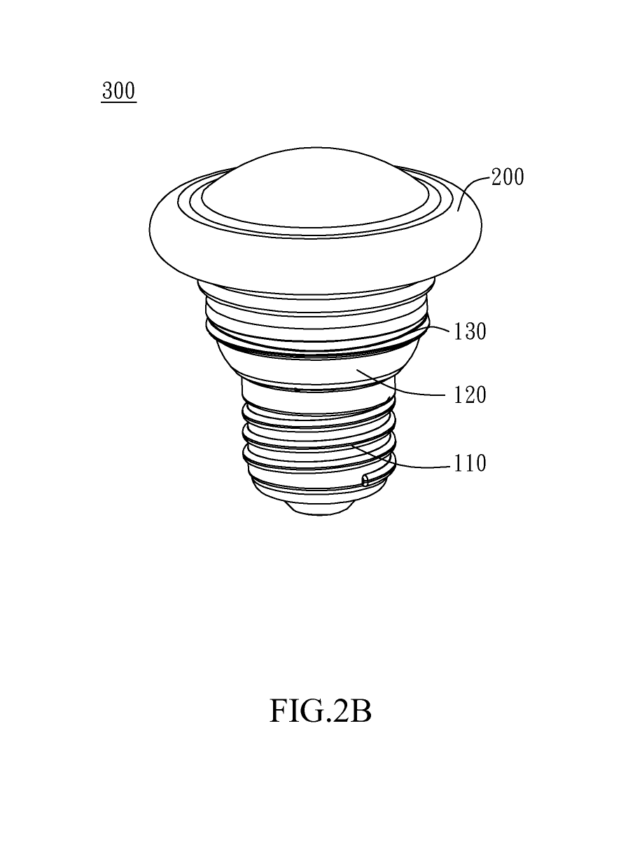

FIG. 2A and FIG. 2B portray a first schematic view and a second schematic view of a lamp with power converter contained base of one preferred embodiment in accordance with the present invention. The lamp with power converter contained base 300 may comprise the power converter contained base 100 and the light-emitting member 200, wherein the power converter contained base 100 may comprise the first commercial standard base 110, the fundament 120, the cover 130, the power converter 140 and the first connector 150. As shown in FIG. 2A, the two ends of the fundament 120 may respectively comprise a first opening 121 and the second opening 122. The first opening 121 may be connected to the first commercial standard base 110, and the cover 130 may be disposed at the second opening 122, and an accommodating space may be defined by the cover 130, the fundament 120 and the first commercial standard base 110. The power converter 140 is disposed at the accommodating space. In some preferred embodiments, the fundament 120, the cover 130, and even the first connector 150 may be integrally formed.

As described above, the first connector 150 may be disposed at the cover 130 or the fundament 120, and the power converter contained base 100 may be connected to the second connector 250 of the light-emitting member 200 through the first connector 150, wherein the first connector 150 and the second connector 250 may be a set of hook and notch or a set of male thread and female thread, a set of second commercial standard base or the like. Similarly, in the preferred embodiment, the GU type socket is just taken as an example for illustrating the first connector 150. The first connector 150 may be other commercial standard sockets, such as B22D and the like, or various electrical connection bases or sockets. Apparently, these electrical connection bases and sockets may be just used in fixation and connection instead of electrical connection. The aforementioned are just some preferred embodiments, and those skilled in the art would easily understand that the first connector and the second connector may comprise more embodiments, which should be in a range limited by the specification of the present invention.

The light-emitting member 200 may comprise a second connector 250 corresponding to the first connector 150. The first connector 150 may be connected to the second connector 250 to make the first commercial standard base 110, the power converter 140, the one of or the combination of two or three of, the fundament 120, the cover 130 and the first connector 150, and the light-emitting member 200 become electrically connected. As described above, the fundament 120 and the cover 130 may be further disposed with a power adjustment component electrically connected to the power converter 140 in order to directly or indirectly adjust the output of the power converter 140.

It would be easily understandable that the first connector 150 and the second connector 250 may be made of material with low thermal conductivity to almost completely or completely prevent thermal from being conducted to the power converter contained base.

It is worthy to point out that the special design of the present invention makes it possible for each of the components of the lamp with power converter contained base according to the present invention to be separately modularized and manufactured. Accordingly, the present invention is more convenient and of higher commercial value than the prior art. Besides, the present invention may further comprise a power adjustment component disposed at the cover or the fundament, which makes it possible for the power converter contained base to be connected to various light-emitting members with different power. Thus, the present invention is more flexible in use than the prior art.

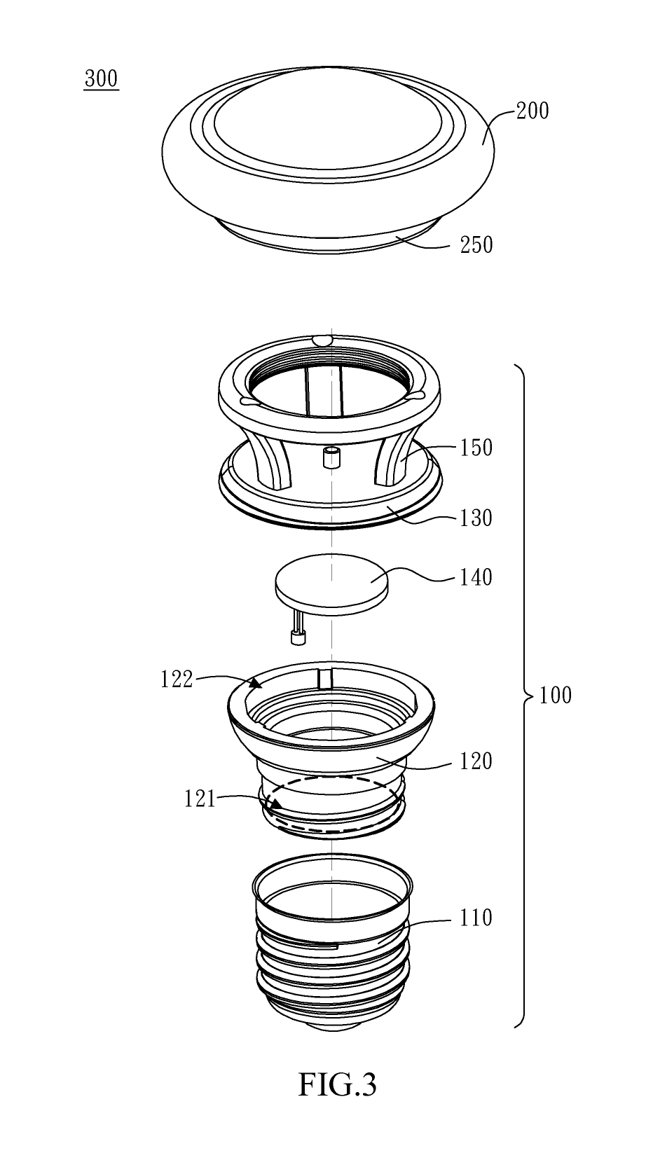

Please refer to FIG. 3 for a schematic view of a lamp with separable power converter contained base of one preferred embodiment in accordance with the present invention. In the preferred embodiment, the power converter contained base 100 is separable. The lamp with power converter contained base 300 may comprise a power converter contained base 100 and a light-emitting member 200. The power converter contained base 100 may comprise a first commercial standard base 110, a fundament 120, a cover 130, a power converter 140 and a first connector 150. As shown in FIG. 3 the first opening 121 of the fundament 120 may be connected to the first commercial standard base 110, and the cover 130 may be disposed at the second opening 122 of the fundament 120. An accommodating space may be defined by the cover 130, the fundament 120 and the first commercial standard base 110 to accommodate the power converter 140. The first connector 150 may be disposed at the cover 130 for the power converter contained base to be connected to and fixed to the second connector 250 of the light-emitting member 200.

In the embodiment, the first connector 150 may comprise male thread and the second connector may comprise female thread which can be fastened to the male thread. Similarly, the first connector 150 and the second connector 250 may be a set of hook and notch or the like. In the embodiment, the cover 130 does not contact the light-emitting member 200, and a space is left between them, which is different from the aforementioned embodiments. As air can pass through the space, the space is helpful to thermal dissipation and thermal insulation. Accordingly, the space can almost entirely or entirely block thermal generated by the light-emitting member 200 from the power converter contained base 100.

The cover 130 can be, no matter the cover 130 contacts the light-emitting member 200 or not, electrically connected to the light-emitting member 200 via the second connector 250 with electrical conductivity after the first connector 150 is connected to the second connector 250. In some preferred embodiments, the first connector 150 and the second connector 250 are just used in fixation and connection, and the cover 130 may be electrically connected to the light-emitting member 200 via extra electric wires, fool-proof device or the like.

Besides, the second connector 250 may be disposed at a thermal dissipater (not shown), and the light-emitting member 200 may be also disposed at the thermal dissipater. Therefore, the power converter contained base 100 may be connected to the second connector 250 through the first connector 150 in order to be electrically connected to the light-emitting member 200 through the first connector 150 and the thermal dissipater. Thermal generated by the light-emitting member 200 may be dissipated by the thermal dissipator, which can enhance the thermal dissipation of the apparatus and block the thermal generated by the light-emitting member 200 from the power converter 140.

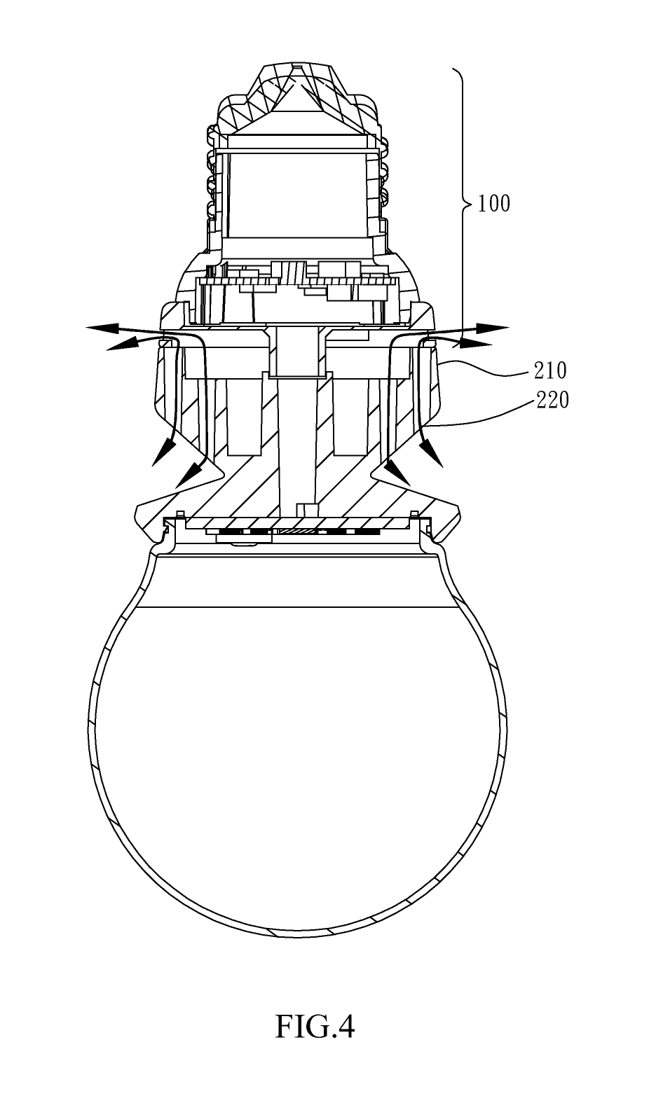

Please refer to FIG. 4, the lamp with power converter contained base 300 may further comprise a plurality of thermal dissipation paths 220, and each of the thermal dissipation paths 220 penetrates the thermal dissipator 210 from its upper surface to its lower surface, such that air may flow in the paths designated by the arrows in FIG. 4. The surface area of the thermal dissipator 210 may be increased with the number of the thermal dissipation paths. As the thermal dissipation ability of the thermal dissipator 210 can be significantly increased, the power converter contained base is applicable to a light-emitting member with higher power. The aforementioned are just some preferred embodiments, and those skilled in the art would easily understand that the first connector, the second connector and the thermal dissipator may comprise more embodiments, which should be in a range limited by the specification of the present invention.

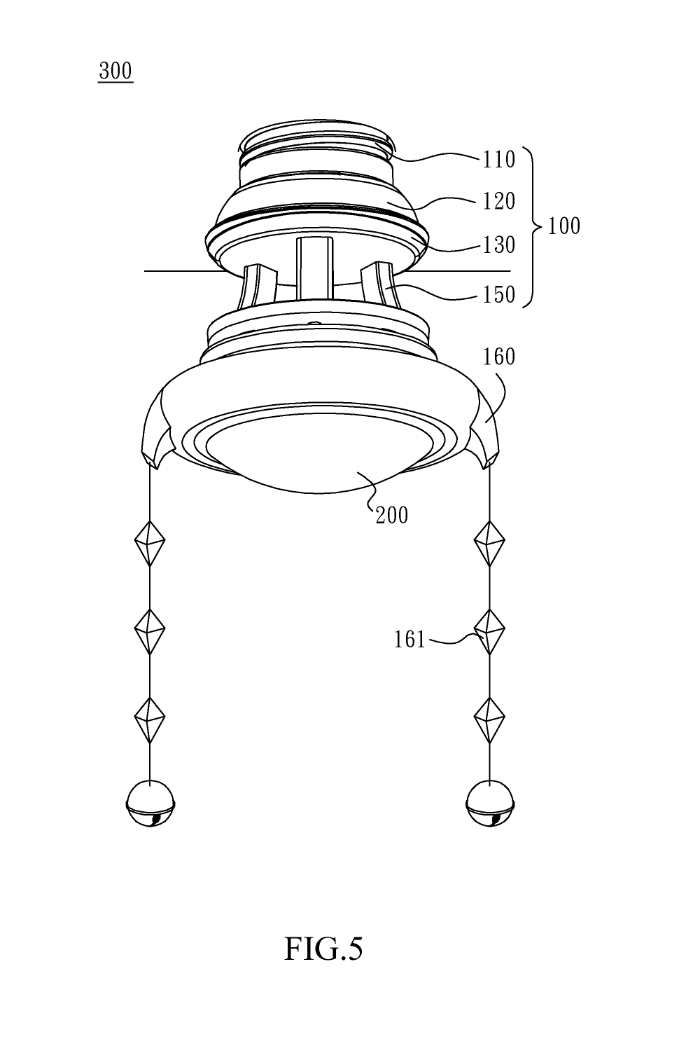

Please refer to FIG. 5 for a schematic view of a lamp with separable power converter contained base of another preferred embodiment in accordance with the present invention. As shown in FIG. 5, the difference with FIG. 3 is that lamp 300 further comprises a third connector 160. In the embodiment, the third embodiment 160 is disposed at the light-emitting member 200, which may be connected to and fixed to a decorative component 161 to change lamp's appearance and make it more beautiful. Alternatively, the third component 160 may also be disposed at the fundament 120 or the cover 130. The decorative component 161 may comprise light-emitting strip, light refraction object, light reflection object and decorative lamp shade and the like. The aforementioned are just some preferred embodiments, and those skilled in the art would easily understand that the third connector and the decorative component may comprise more embodiments, which should be in a range limited by the specification of the present invention.

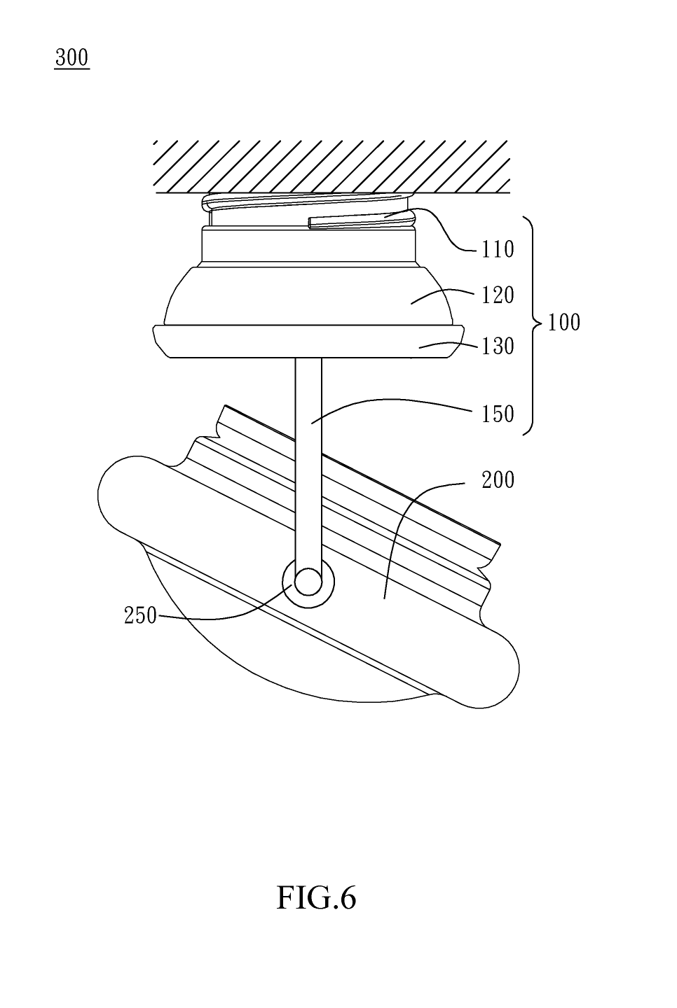

Please refer to FIG. 6 for a schematic view of a lamp with separable power converter contained base of still another preferred embodiment in accordance with the present invention. As shown in FIG. 6, the different with the aforementioned embodiments is that the first connector is two connection bars 150 disposed opposite to each other, wherein one end of each of the connection bars 150 is fixed to the cover 130, and the other end of each of the connection bars 150 is pivotally connected to the corresponding second connector 250. In this way, the lighting direction of the light-emitting member 200 may be adjusted.

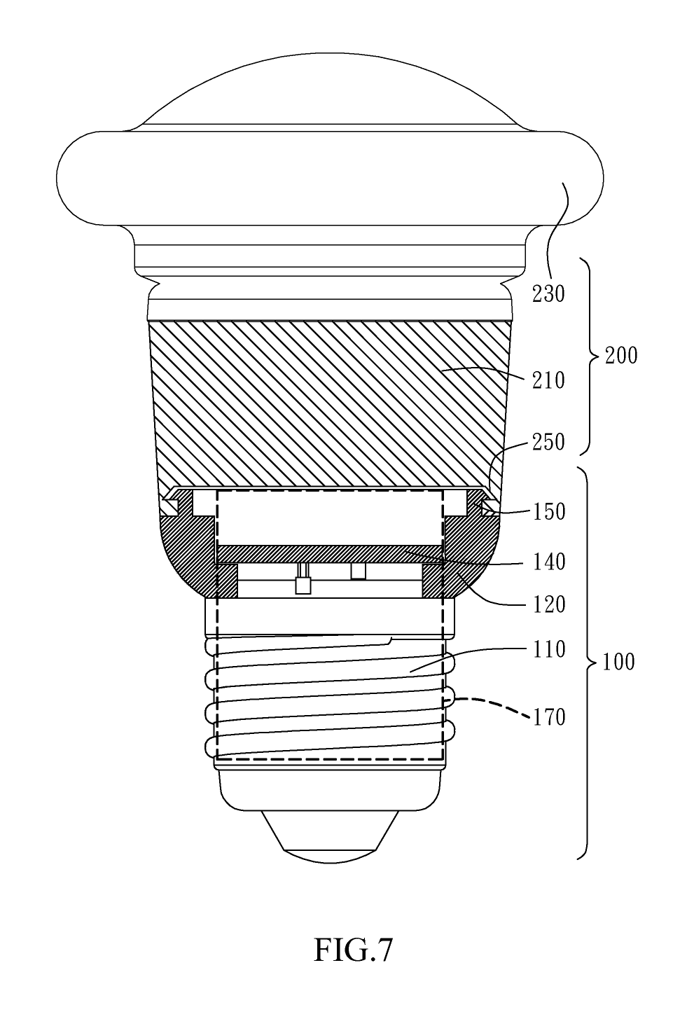

Please refer to FIG. 7 for a schematic view of a lamp with power converter contained base of another preferred embodiment in accordance with the present invention. The lamp with power converter contained base 300 may comprise a power converter contained base 100 and a light-emitting member 200. The power converter contained base 100 may comprise a first commercial standard base 110, a fundament 120, a power converter 140 and a first connector 150. The first opening of the fundament 120 may be connected to the first commercial standard base 110, and an accommodating space may be defined by the fundament 120 and the first commercial standard base 110 to accommodate the power converter 140. The light-emitting member 200 may comprise a thermal dissipator 210, a light-emitting module 230 and a second connector 250 disposed at the thermal dissipator 210. As shown in FIG. 7, in the embodiment, the first connector 150 and the second connector 250 are a set of hook and notch. The first connector 150 may be disposed at the fundament 120 to engage with the second connector 250 disposed at the thermal dissipator 210, such that the thermal dissipator 210 can cover the second opening of the fundament 120 for the first commercial standard base 110, the power converter 140 and the light-emitting member to be electrically connected to each other via electric wires or direct contact.

The aforementioned are just some preferred embodiments, and those skilled in the art would easily understand that the thermal dissipator may comprise more embodiments, which should be in a range limited by the specification of the present invention.

In summation of the description above, according to the present invention, as the thermal generated by the power converter may be dissipated through the metal base and the corresponding conductive wires, the power converter can work normally. Each of the components of the lamp according to the present invention may be separately modularized to be respectively manufactured. Accordingly, the light-emitting member or other components may be replaced according to actual requirements. In addition, the base may be further disposed with a power adjustment component for adjusting the power converter's power to match the light-emitting member's. Thus, the present invention is more convenient for users and of higher commercial value. Also, the present invention may comprise a thermal insulation space between the cover and the light-emitting member, which is very helpful to thermal dissipation and insulation. According, the performance of the power converter can be improved. The present invention may further comprise a third connector to be connected to various decorative components, which can make the lamp more beautiful. Moreover, according to the present invention, the power converter is disposed in the accommodating space inside the base and thereby the metal housing of the base can effectively block the electromagnetic radiation generated by the power converter when the power converter is working.

While the means of specific embodiments in present invention has been described by reference drawings, numerous modifications and variations could be made thereto by those skilled in the art without departing from the scope and spirit of the invention set forth in the claims. The modifications and variations should be in a range limited by the specification of the present invention.

What is claimed is:

1. A power converter contained base, comprising:
a first commercial standard base;
a fundament, wherein two ends of the fundament respectively comprise a first opening and a second opening, and the first opening is connected to the first commercial standard base;
a cover disposed at the second opening of the fundament, wherein an accommodating space is defined by the cover, the fundament and the first commercial standard base;
a power converter disposed in the accommodating space; and
a first connector disposed at the cover or the fundament, wherein the first connector is used to connect the power converter contained base with a second connector of a lighting-emitting member to make the first commercial standard base, the power converter, the one of or the combination of two or three of, the fundament, the cover and the first connector, and the light-emitting member become electrically connected.

2. The power converter contained base of claim 1, wherein the accommodating space further comprises a thermal conducting material for conducting thermal generating by the power converter to the first commercial standard base.

3. The power converter contained base of claim 1, wherein the first connector and the second connector are a set of hook and notch or a set of male thread and female thread or a set of a second commercial standard base.

4. The power converter contained base of claim 3, wherein the second commercial standard base further comprises a fool-proof device.

5. The power converter contained base of claim 1, wherein the fundament and the cover are integrally formed.

6. The power converter contained base of claim 1, wherein the fundament or the cover further comprises a power adjustment component for directly or indirectly adjusting an output of the power converter.

7. A lamp with a separable power converter contained base, comprising:
a power converter contained base, wherein the power converter contained base comprises a first commercial standard base; a fundament having a first opening at one end thereof and a second opening at the other end thereof, and the first opening is connected to the first commercial standard base; a cover disposed at the second opening of the fundament, wherein an accommodating space is defined by the cover, the fundament and the first commercial standard base; a power converter disposed in the accommodating space; and
a light-emitting member comprising a second connector;
wherein the power converter contained base further comprises a first connector, and the first connector is disposed at the cover or the fundament, and the first connector is used to connect the power converter contained base with and fix the power converter contained base to the second connector of the light-emitting member in order to make the first commercial standard base, the power converter, the one of or the combination of two or three of, the fundament, the cover and the first connector, and the light-emitting member become electrically connected.

8. The lamp of claim 7, wherein the accommodating space further comprises a thermal conducting material for conducting thermal generating by the power converter to the first commercial standard base.

9. The lamp of claim 7, wherein the first connector and the second connector are a set of hook and notch or a set of male thread and female thread or a set of second commercial standard base.

10. The lamp of claim 9, wherein the second commercial standard base further comprises a fool-proof device.

11. The lamp of claim 7, wherein the fundament and the cover are integrally formed.

12. The lamp of claim 7, wherein the fundament or the cover further comprises a power adjustment component for directly or indirectly adjusting an output of the power converter.

13. The lamp of claim 7, wherein the cover contacts the light-emitting member after the first connector is connected to and fixed to the second connector.

14. The lamp of claim 7, wherein the cover does not contact the light-emitting member and there is a room between the cover and the light-emitting member, and the cover is electrically connected to the light-emitting member through a contact of the first connector and the second connector after the first connector is connected to and fixed to the second connector.

15. The lamp of claim 14, wherein the first connector is two connection bars disposed opposite to each other, and one end of each of the connection bars is fixed to the cover or the fundament, and the other end of each of the connection bars is pivotally connected to the corresponding second connector.

16. The lamp of claim 7, wherein the light-emitting member comprises a thermal dissipator and a light-emitting module, and the second connector is disposed at the thermal dissipator.

17. The lamp of claim 16, wherein the thermal dissipator further comprises a plurality of thermal dissipation paths, and each of the thermal dissipation paths penetrates the thermal dissipator from upper surface thereof to lower surface thereof.

18. The lamp of claim 7, further comprising a third connector, wherein the third connector is disposed at the fundament, the cover or the light-emitting member in order to be connected to or fixed to a decorative component.

19. The lamp of claim 18, wherein the decorative component comprises light-emitting strip, light refraction object, light reflection object and decorative lamp shade.

20. A lamp with a power converter contained base, comprising:
a power converter contained base, wherein the power converter contained base comprises a first commercial standard base; a fundament having a first opening at one end thereof and a second opening at the other end thereof, and the first opening is connected to the first commercial standard base, wherein an accommodating space is defined by the fundament and the first commercial standard base; a power converter disposed in the accommodating space; and
a light-emitting member comprising a thermal dissipator, a light-emitting module and a second connector disposed at the thermal dissipator;
wherein the power converter contained base further comprises a first connector, and the first connector is disposed at the fundament, and the first connector is used to connect the power converter contained base with and fix the power converter contained base to the second connector of the thermal dissipator in order to make the thermal dissipator cover the second opening of the fundament and make the first commercial standard base, the power converter and the light module electrically connected to each other.

21. The lamp of claim 20, wherein the accommodating space further comprises a thermal conducting material for conducting thermal generating by the power converter from the power converter to the first commercial standard base.

22. The lamp of claim 20, wherein the first connector and the second connector are a set of hook and notch or a set of male thread and female thread or a set of second commercial standard base.

23. The lamp of claim 22, wherein the second commercial standard base further comprises a fool-proof device.
